(19) United States
(12) Patent Application Publication
(10) Pub. No.: US 2015/0307049 A1
(43) Pub. Date: Oct. 29, 2015

(54) SHOCK ABSORBING AUXILIARY MEMBER FOR ABSORBING SHOCK IN HEAD LINING OF VEHICLE

(71) Applicant: DAEHAN SOLUTION CO., LTD., Incheon (KR)

(72) Inventor: Choong Ho KWON, SEOUL (KR)

(73) Assignee: DAEHAN SOLUTION CO., LTD., INCHEON (KR)

(21) Appl. No.: 14/475,842

(22) Filed: Sep. 3, 2014

(30) Foreign Application Priority Data
Apr. 25, 2014 (KR) 10-2014-0049819

(51) Int. Cl. B60R 21/04; F16F 7/12

(52) U.S. Cl. CPC B60R 21/04; F16F 7/122; B60R 2021/0442; B60R 2021/0414

(57) ABSTRACT

An auxiliary member for absorbing shock in a head lining of a vehicle, in which a corrugation member having corrugated portions continuously formed to be long in a transverse direction of the vehicle is installed between the head lining and a roof panel, and particularly, each of the corrugated portions may be divided into various areas according to a distance between the head lining and the roof panel, and a width of each area may be selected from various set widths according to head injury criterion (HIC(d)) based on a height of each area, such that the areas may have different widths even when having the same height. Thus, the auxiliary member may be designed to satisfy optimum conditions without interference between the roof panel and the head lining and degradation of shock absorbing performance.

### CROSS-REFERENCE TO RELATED APPLICATION

This application claims priority to and the benefit of Korean Patent Application No. 10-2014-0049819, filed on Apr. 25, 2014, the disclosure of which is incorporated herein by reference in its entirety.

### BACKGROUND

1. Field of the Invention

The present invention relates to an auxiliary member for absorbing shock in a head lining of a vehicle, and more particularly, to an auxiliary member for absorbing shock in a head lining of a vehicle, in which a corrugation member having a plurality of corrugated portions formed to be parallel is installed between the head lining and a roof panel, and the corrugated portions forming the corrugation member are formed to have various heights and widths according to a distance between the head lining and the roof panel, thereby satisfying optimal head injury criteria capable of enhancing shock absorbing efficiency compared with a conventional cone-shaped auxiliary member.

2. Discussion of Related Art

Generally, when a vehicle crash (or collision) occurs, a driver's body or passengers' bodies may be forced to one side due to inertial force, hit by interior decorations or accessories in a vehicle, and then secondarily injured. Particularly, when a vehicle speed or an impulse has a predetermined value or more, a head part may be hit and injured by components of the interior decorations.

Therefore, in order to minimize shock applied to the head when the vehicle accident occurs and increase safety performance, an auxiliary member for absorbing the shock is installed in the vehicle. As the regulations for the auxiliary member, for example, there is a protocol of the FMVSS 201U standard of the National Highway Traffic Safety Administration (NHTSA) in the U.S. These regulations are to prevent an injury to the head due to upper interior components such as a pillar, a side rail, a header, and a roof panel when the vehicle crash occurs.

To this end, the auxiliary member for absorbing the shock is provided at a position at which the injury to the head is expected. A type of the auxiliary member includes a cone type, a rib type, a CAB bracket type, and so on.

A patent document 1 relates to a shock absorbing structure of a bracket type vehicle pillar, and more particularly, to a shock absorbing structure of a vehicle pillar, in which a mounting bracket configured to reduce the shock when the vehicle crash occurs is installed between a D-pillar inner panel and a D-ring portion having a D-ring installed in a vehicle body, characterized by the mounting bracket having a [symbol] -shape which forms a deformation space therein, and is fixed to the D-pillar inner panel, thereby reducing an injury value due to the vehicle crash and increasing FMH performance.

A patent document 2 discloses a shock absorbing auxiliary member for a vehicle, of which a mold may be easily prepared regardless of a shape thereof, an entire weight may be reduced, and also a waste disposal problem does not occur when disposing thereof because the auxiliary member is manufactured of pulp containing a biodegradable plastic resin. Further, since a rib is connected between hollow protuberant portions and thus the shock absorbing auxiliary member is integrally formed, it is possible to provide sufficient shock absorbing performance required in the shock absorbing auxiliary member through continuous deformations of the protuberant portions and the rib.

However, in case of the bracket type, there is a limitation in sufficiently absorbing the shock applied to an outer side of the vehicle, and thus, the auxiliary member is mainly formed in the cone type. FIG. 1 illustrates a cone type auxiliary member. As illustrated in FIG. 1, a plate-shaped auxiliary absorbing member 10 attached to an inner side of the vehicle is used. The auxiliary absorbing member 10 is formed in a plate shape having a predetermined size, and hollow cone portions 11 configured to absorb shock are integrally formed with one surface thereof to be disposed in a plurality of rows spaced apart at predetermined regular intervals. In the auxiliary absorbing member 10, the shock is applied to the cone portions 11 by the head or the like, and while the hollow cone portions 11 are deformed, the shock is absorbed.

However, there are some problems in the conventional auxiliary absorbing member, as follows.

(1) It is difficult to expect consistent shock absorbing performance with respect to the entire auxiliary absorbing member due to spaces among the cone portions or the like. In particular, since a distance between a head lining and a roof panel is not consistent, and also a reinforcing panel or the like is installed at the roof panel to protrude toward the inner side, each size of the cone portions should be smaller or the distance between the cone portions should be wider to remove interference at these portions, and thus it is difficult to consistently maintain the shock absorbing performance of the auxiliary absorbing member.

(2) If the shock absorbing performance of the manufactured auxiliary absorbing member is short of a standard value, a thickness t of the entire auxiliary absorbing member should be made thicker to improve the shock absorbing performance.

(3) This is one factor that increases an entire weight of the auxiliary absorbing member, and thus, vehicle fuel efficiency is degraded as a result of the increase in weight.

(4) In particular, since the conventional auxiliary absorbing member is manufactured to entirely have a large thickness, the entire auxiliary absorbing member should be formed to be thick, even though it is sufficient to reinforce only the cone portions in which the shock absorbing efficiency may be lower.

(5) Therefore, even unnecessary portions are also formed to be thick, and the shock absorbing performance is lower contrary to the thick thickness, and also the vehicle fuel efficiency is degraded as a result of the increase in weight.

(Patent document 1) Korean Patent No. 0811941 (registered on Mar. 3, 2008)

(Patent document 2) Korean Patent No. 1342911 (registered on Dec. 12, 2013)

### SUMMARY OF THE INVENTION

The present invention is directed to an auxiliary member for absorbing shock in a head lining of a vehicle, in which a corrugation member having corrugated portions continuously formed to be long in a transverse direction of the vehicle is installed between the head lining and a roof panel, and particularly, each of the corrugated portions may be divided into various areas according to a distance between the head lining and the roof panel, and a width of each area may be selected from various widths set according to head injury criterion (HIC(d)) based on a height of each area, such that the areas may have different widths even when having the same height, and thus which may be designed to satisfy optimal conditions without interference between the roof panel and the head lining and degradation of shock absorbing performance, even though the distance between the roof panel and the head lining is changed by a reinforcing member (or panel) or the like installed inside the roof panel.

Also, the present invention is directed to an auxiliary member for absorbing shock in a head lining of a vehicle, which may previously measure an injury value according to the HIC(d) so as to satisfy the HIC(d) required in the auxiliary member, while changing each of the corrugated portions of the corrugation member by the predetermined height and width, and thus may be selectively designed from the various widths preset to satisfy the HIC(d) according to the heights of the corrugated portions, and thus may be easily designed to provide the optimal shock absorbing performance.

According to an aspect of the present invention, there is provided an auxiliary member for absorbing shock in a head lining of a vehicle, including a corrugation member (100) which is installed between a roof panel (R) and a head lining (L) and in which a plurality of corrugated portions (110) are continuously and repeatedly formed to be long in a transverse direction of the vehicle, wherein each of the corrugated portions (110) is divided into at least two areas (A) having heights (h) which are connected with each other and are the same as or similar to a distance (G) between the roof panel (R) and the head lining (L), and a height (h) of each area is selected to have a height (H) which is the same as or less than the distance (G), and a width (w) of each area is selected from set multiple widths (W) based on the selected height (H), and a corrugation member (C), in which the corrugation portions having the same sizes are repeatedly formed, is inserted between the roof panel (R) and the head lining (L), and tested according to the HIC(d) while the width (W) is changed by a unit width (W′) in a state in which the height (H) is fixed, and then tested again while the height (H) is changed by a unit height (H′) and the width (W) is also changed by the unit width (W′), and a height and a width in which a head injury value is 1000 or less are obtained, and the height (H) and the width (W) are the height and width in which the head injury value is 1000 or less.

The injury value may be measured while the height (H) is incrementally changed from 0 to 50 mm by a unit height (H′) of 5 mm, and the width (W) is incrementally changed from 0 to 100 mm by a unit width (W′) of 5 mm.

The roof panel (R) and a distal end of the corrugated portion (110) may be formed to be spaced apart from each other by a predetermined gap (g), and the gap (g) may be 3 to 6 mm.

The HIC(d) may follow the protocol of the FMVSS 201U standard of the National Highway Traffic Safety Administration (NHTSA) in the U.S.

### BRIEF DESCRIPTION OF THE DRAWINGS

The above and other objects, features, and advantages of the present invention will become more apparent to those of ordinary skill in the art by describing in detail exemplary embodiments thereof with reference to the accompanying drawings, in which:

FIG. 1 is a perspective view illustrating an example of a conventional cone type shock absorbing auxiliary member;

FIG. 2 is a cross-sectional view taken along line A-A of FIG. 1 to illustrate a cross-section of the cone type shock absorbing auxiliary member;

FIG. 3 is a cross-sectional view conceptually illustrating a shape of an auxiliary member for absorbing shock in a head lining of a vehicle according to the present invention;

FIG. 4 is a perspective view conceptually illustrating the shape of the auxiliary member for absorbing shock in the head lining of the vehicle according to the present invention;

FIG. 5 is an exploded perspective view illustrating an example in which the auxiliary member for absorbing shock in the head lining of the vehicle according to the present invention is disposed between a roof panel and a head lining of the vehicle;

FIG. 6 is a perspective view illustrating an example of a corrugation member in which the auxiliary member for absorbing shock in the head lining of the vehicle according to the present invention is applied to the vehicle;

FIG. 7 is a cross-sectional view illustrating a method of calculating a head injury value according to heights and widths of corrugated portions according to the present invention;

FIG. 8 is a conceptual view illustrating a method of changing the heights and the widths of the corrugated portions in a unit height and a unit width according to the present invention;

FIG. 9 is a diagram illustrating the heights and the widths of the corrugated portions obtained according to the present invention; and

FIGS. 10 to 13 are diagrams divided into quadrants to illustrate the diagram of FIG. 9 in detail.

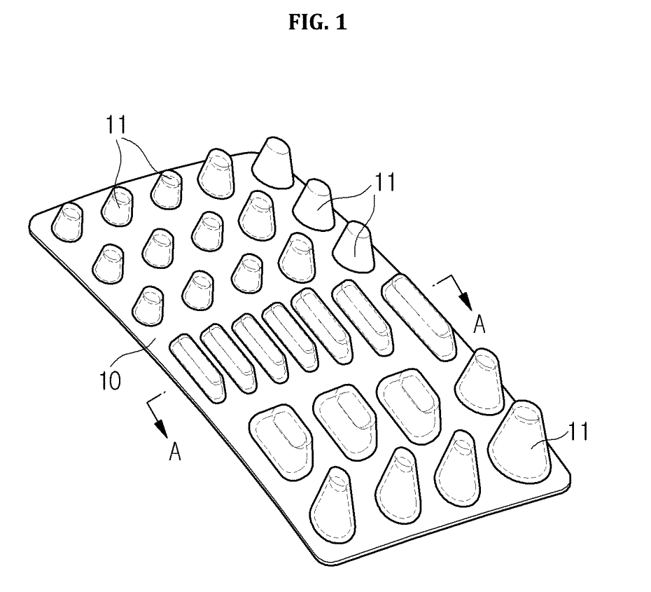

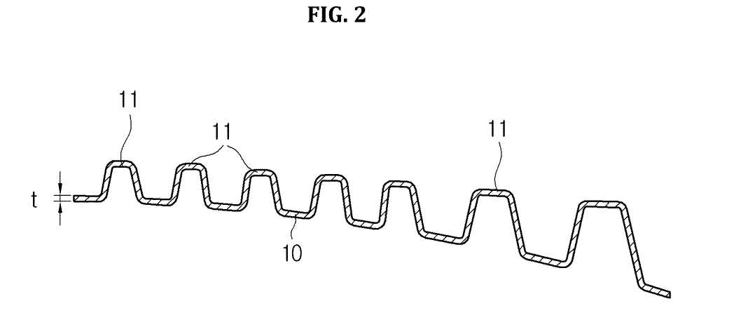

Elements:

| | |
|---|---|
| 100: corrugation member | 110: corrugated portion |
| H: height | W: width |

### DETAILED DESCRIPTION OF THE INVENTION

Hereinafter, the embodiments of the present invention will be described in detail with reference to the accompanying drawings. However, it should be understood that the terms used in the specification and the appended claims should not be construed as limited to general and dictionary meanings, but interpreted, based on the meanings and concepts corresponding to technical aspects of the present invention on the basis of the principle that the inventor is allowed to define terms appropriately for the best explanation.

Therefore, the description proposed herein is just a preferable example for the purpose of illustrations only, not intended to limit the scope of the invention, so it should be understood that other equivalents and modifications could be made thereto without departing from the spirit and scope of the invention.

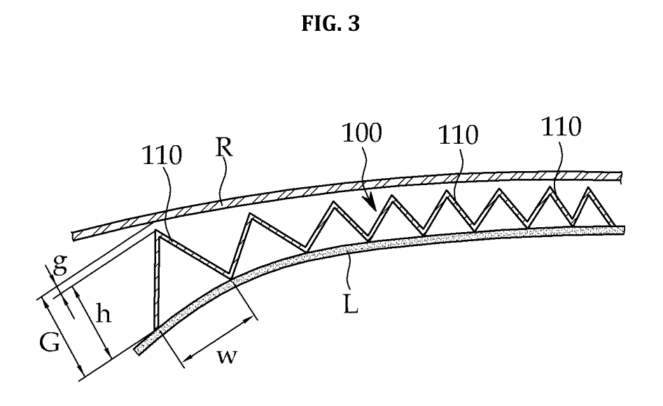

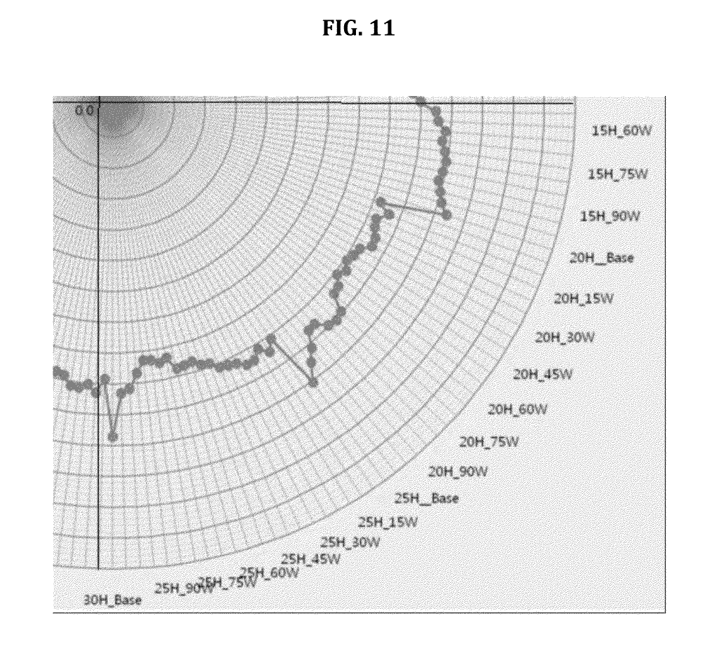

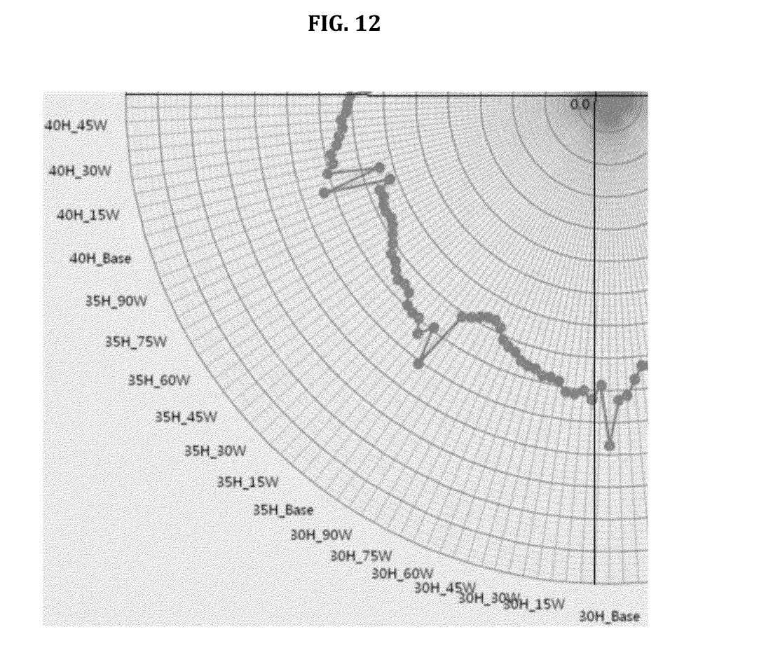

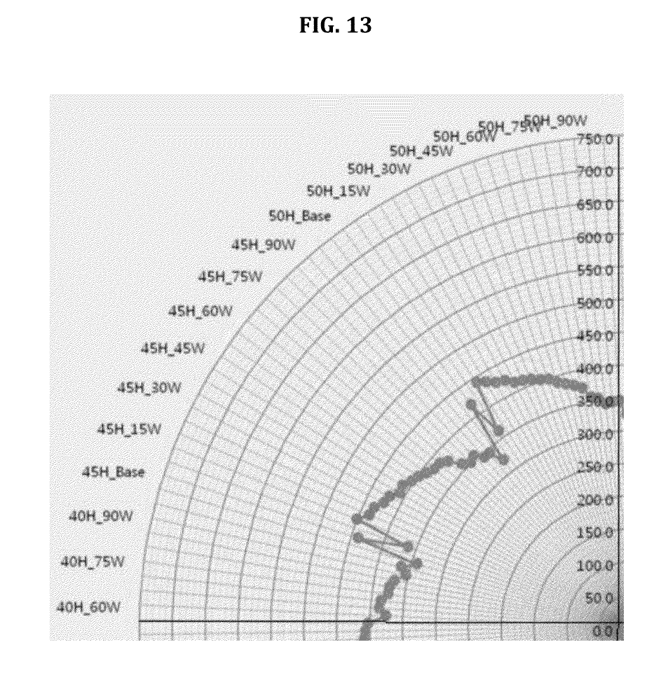

As illustrated in FIGS. 3 to 13, an auxiliary member for absorbing shock in a head lining of a vehicle according to the present invention is formed of a corrugation member 100 in which a plurality of corrugated portions 110 having different heights h and widths w according to a distance G between a roof panel R and a head lining L are continuously and repeatedly formed.

Particularly, each of the corrugated portions 110 is formed to be long in a transverse direction of the vehicle. At this time, each corrugated portion 110 is connected in a state of being divided into at least two areas A according to a change in the distance G, and each area is formed in a corrugated shape which has an injury value of 1000 or less when being measured according to head injury criterion (HIC(d)) and particularly has a height h and a width w determined by selecting one of multiple widths w with respect to a predetermined height h.

Hereinafter, this configuration will be described more specifically.

As illustrated in FIG. 3, the auxiliary member for absorbing shock according to the present invention is formed of the corrugation member 100 in which the plurality of corrugated portions 110 are continuously formed. At this time, the corrugated portions 110 have different heights h and widths w according to the distance G between the roof panel R and the head lining L.

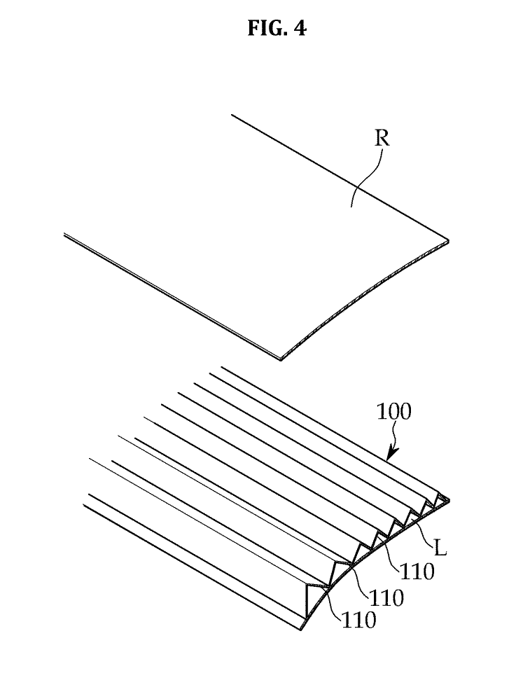

In particular, each of the corrugated portions 110 of the corrugation member 100 is formed to be long in the transverse direction of the vehicle. At this time, when the roof panel R and the head lining L are formed to be parallel with each other as illustrated in FIG. 4, the corrugated portions 110 have constant heights h and widths w. That is, when the roof panel R and the head lining L are parallel with each other, the distance G therebetween is constant in the transverse direction of the vehicle, and thus the corrugated portions 110 formed in the distance G have constant heights h and widths w.

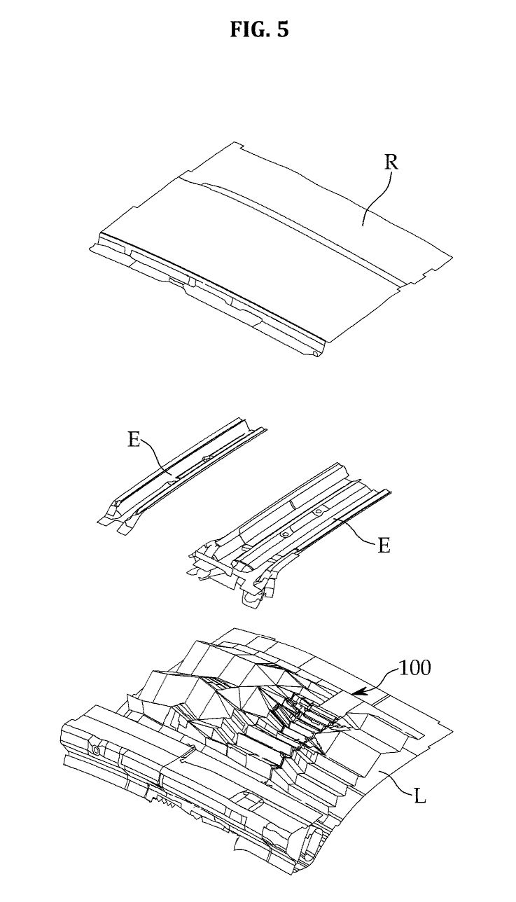

However, in the actual vehicle, as illustrated in FIG. 5, the roof panel R and the head lining L are formed to be bent in the transverse direction of the vehicle due to a design aspect, and particularly, since a reinforcing panel E installed at the roof panel R to reinforce strength of the vehicle protrudes toward an indoor side, the distance between the roof panel R and the head lining L is not constant in the transverse direction of the vehicle, as illustrated in FIG. 4.

Therefore, in the present invention, as the height h corresponding to the distance G changed in the transverse direction of the vehicle is selected, an optimal width w may be determined from multiple widths having the injury value of 1000 or less when being measured according to the HIC(d).

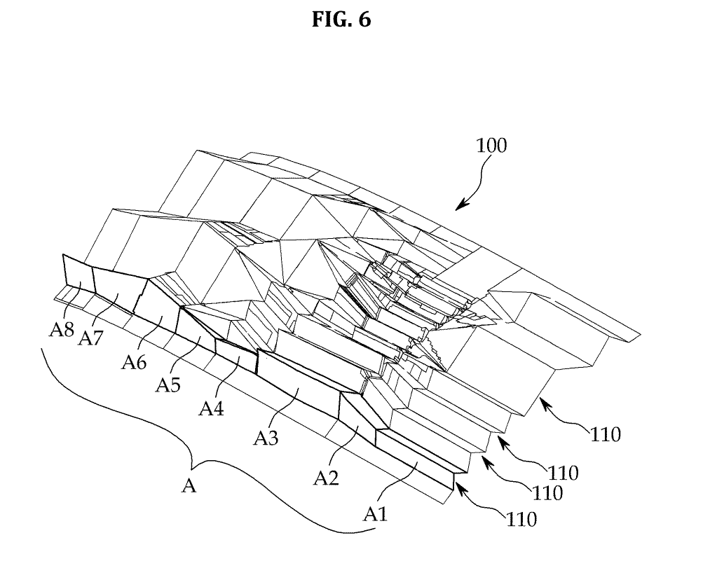

More specifically, as illustrated in FIGS. 5 and 6, the corrugation member 100 is configured of the plurality of corrugated portions 110. One corrugated portion is divided into multiple areas A such as a first corrugated portion 110 disposed at the frontmost position of FIG. 6. The drawing illustrates an example in which the first corrugated portion 110 is divided into eight areas A1 to A8.

At this time, the distance G between the roof panel R and the head lining L is measured with respect to one corrugated portion 110 formed to be long in the transverse direction of the vehicle, and then these areas A1 to A8 are divided according to sharply changed positions. That is, the first area A1 has the corrugated portion 110 whose top is formed to be flat, and this means that the distance G of the first area A1 is constant. The second area A2 has the corrugated portion 110 whose top becomes higher toward a left side of the drawing, and this means that the distance G gradually becomes greater than the first area A1, and thus the height of the corrugated portion also becomes higher.

Meanwhile, the height h and the width w of the corrugated portion are selected from various values previously measured according to the HIC(d). In the embodiment of the present invention, the HIC(d) has the injury value of 1000 or less according to the protocol of the FMVSS 201U standard of the National Highway Traffic Safety Administration (NHTSA) in the U.S.

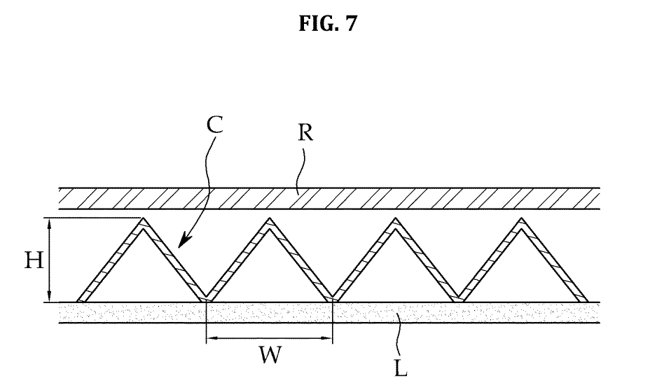

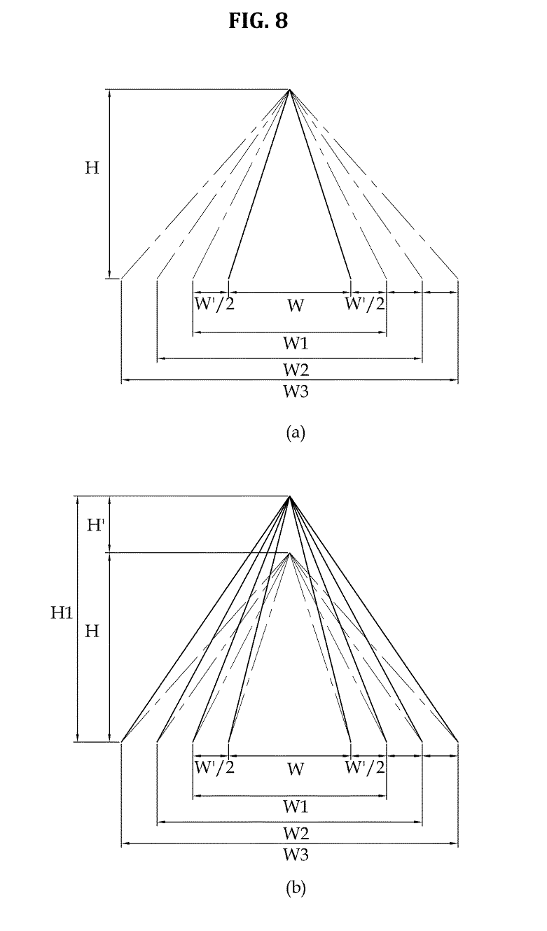

That is, as illustrated in FIGS. 7 and 8, a corrugation member C in which the corrugated portions having predetermined heights H and widths W are continuously formed is installed between the roof panel R and the head lining L, and then the injury values according to the HIC(d) when a shock is applied at a speed preset according to the rules of FMVSS 201U, for example, a speed of 19 km/h is measured.

And as illustrated in FIG. 8, in the corrugation member C, the injury values are measured while the height H and the width W of each corrugated portion are changed by predetermined unit height H′ and unit width W′. That is, as illustrated in FIG. 8A, the injury value is measured with respect to the corrugation member manufactured to have a reference width W with respect to a predetermined height H, and then each injury value is measured with respect to the corrugation members having widths W1, W2, and W3 in which the unit width W′ is added to the reference width. And as illustrated in FIG. 8B, the injury value is measured with respect to the corrugation member having the reference width W with respect to a height in which a predetermined unit height H″ is added to the height H, and then each injury value is measured with respect to the corrugation members having the widths W1, W2, and W3 in which the unit width W′ is added to the reference width.

In the embodiment of the present invention, the head injury value may be measured while the height H is incrementally changed from 0 to 50 mm by a unit height H′ of 5 mm, and the width W is incrementally changed from 0 to 100 mm by a unit width W′ of 5 mm. At this time, the height H considers a range of the distance G between the roof panel R and the head lining L, and the width W is set to about twice of the height H.

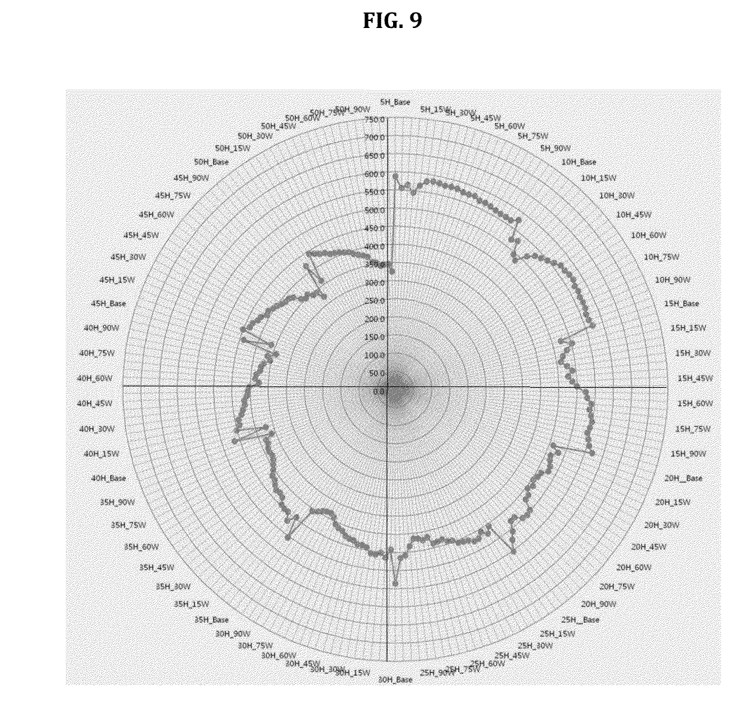

Meanwhile, FIG. 9 illustrates the injury value of the HIC(d) measured according to the rules of FMVSS 201U, while the height H is incrementally increased from 0 to 50 mm by 5 mm and the width W is also incrementally increased from 0 to 100 mm by 5 mm, and it may be understood that the injury value is 1000 or less.

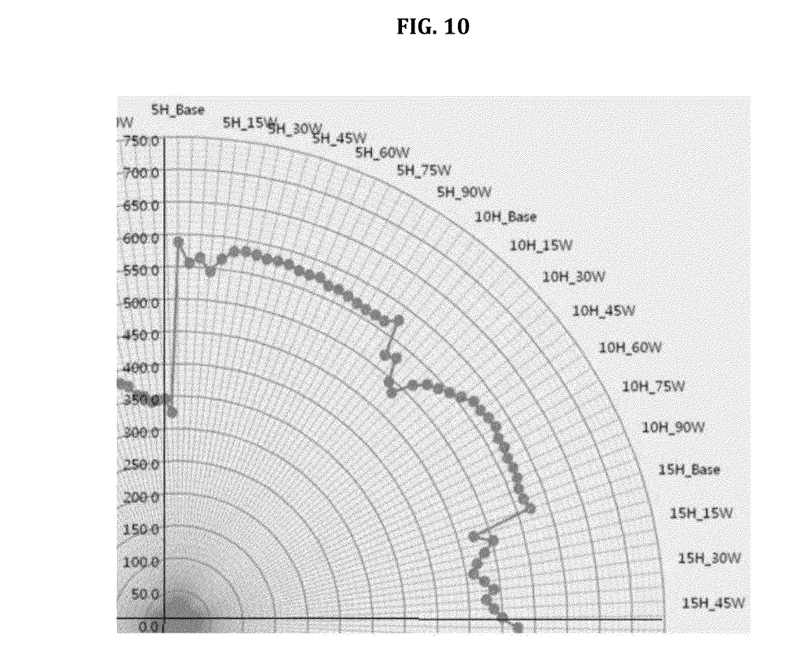

The measured injury value is shown in FIGS. 10 to 13 in which the diagram in FIG. 9 is divided into quadrants. For example, as illustrated in FIG. 10, it may be understood that, in the case in which the width W is within 0 to 900 mm when the height H is 5 mm, i.e., in a section from “5H_Base” to “5H_{—}90W”, the injury value is within 550.0 to 600.0. In the drawing, for example, “5H_{—}15W” means that the height is 5 mm and the width is 15 mm, “Base” means a state of “0”, and a number of the longitudinal axis means the injury value.

As illustrated in FIGS. 9 to 13, the injury value measured at a range of a certain height H and width W is within approximately 320 to 590, and thus, it may be understood that an upper limit value of the HIC(d) is less than 1000.

The height h which is the same as or less than the distance G between the roof panel R and the head lining L is selected from the above-mentioned range of the height H, and then the width w which has a low injury value or is not interfered by a peripheral portion is selected from the multiple widths W with respect to the height H, and thus, the heights h and widths w of the actual corrugated portions in each area A1 to A8 are determined.

Therefore, as illustrated in FIGS. 5 and 6, the auxiliary member for absorbing shock according to the present invention may select the width from the multiple widths W satisfying the injury value of the HIC(d) with respect to the height H detected according to the distance G between the roof panel R and the head lining L, which is changed in a lengthwise direction of one corrugated portion 110 (i.e., in the transverse direction of the vehicle), in consideration of the interference by the peripheral portion or the optimal injury value, and thus, may form the corrugated portion 110 divided into multiple areas A and having the optimal shock absorbing performance.

For convenience of explanation, the embodiment of the present invention describes that the height h and the width w of each of the areas A1 to A8 have the same lengths with respect to one area. That is, in case of the first area A1, the height h and the width w are almost constant over the entire length thereof. However, in case of the second area A2, the height h and the width w may be set differently according to high and low of the distance G. Therefore, in the second area A2, since the distance G is gradually increased toward a left side of the drawing, the height h is gradually increased, and the width w is also gradually increased.

As described above, in each of the divided areas A1 to A8, the height h and the width w of the corrugated portion at starting and ending positions of the area may be constant, or may be gradually smaller or greater. And according to a change in the height h, the optical width w may be selected from the multiple widths W set to correspond to the predetermined height H, as described above.

Further, in the embodiment of the present invention, as illustrated in FIG. 3, the corrugated portion 110 may have the height h selected so that a distal end thereof is spaced apart from the roof panel R by a predetermined gap g. This gap may serve as a clearance and thus the auxiliary member for absorbing shock according to the present invention, which has a narrow and complicated shape, may be easily installed at the roof panel R. At this time, the gap g may be selected within a range of 3 to 6 mm.

The auxiliary member for absorbing shock in the head lining of the vehicle according to the present invention has the following effects.

(1) Since the user can select the optimal width of the multiple widths satisfying the head injury value according to the distance between the head lining and the roof panel, i.e., the height of the corrugated portion, it is possible to optimize the shock absorbing performance of the auxiliary member for absorbing shock within a limited space.

(2) In particular, even though the heights of the corrugated portions are the same, when the auxiliary member protrudes toward the inner side together with the reinforcing panel at the inner side of the roof panel, it is possible to adjust the width of the corrugated portion and thus satisfy the sufficient head injury value without interfering with the reinforcing panel, thereby obtaining the optimal shock absorbing performance.

(3) As described above, since the user can select and use one of the multiple widths previously determined through tests according to the height of the corrugated portion in the previously designed space between the head lining and the roof panel, anyone can easily design the auxiliary member for absorbing shock having the optimum shock absorbing performance.

(4) Even though the shape or the like of the reinforcing panel installed at the roof panel•the head lining•the roof panel is changed, when the user knows the distance between the head lining and the roof panel, i.e., the height, the height and the width can be selected from the values predetermined within the injury values according to the height and the width, and even though a type of the vehicle or a design of the vehicle is changed, the width corresponding to the changed height can be selected, and thus it is possible to easily design the auxiliary member for absorbing shock.

It will be apparent to those skilled in the art that various modifications can be made to the above-described exemplary embodiments of the present invention without departing from the spirit or scope of the invention. Thus, it is intended that the present invention covers all such modifications provided they are within the scope of the appended claims and their equivalents.

What is claimed is:

1. An auxiliary member for absorbing shock in a head lining of a vehicle, comprising:
a corrugation member which is installed between a roof panel and a head lining and in which a plurality of corrugated portions are continuously and repeatedly formed long in a transverse direction of the vehicle,
wherein each of the corrugated portions is divided into at least two areas having heights which are connected with each other and are the same as or similar to a distance between the roof panel and the head lining,
a height of each area is selected to have a height the same as or less than the distance, and a width of each area is selected from set multiple widths based on the selected height, and
a corrugation member, in which the corrugation portions having the same sizes are repeatedly formed, is inserted between the roof panel and the head lining, and tested according to head injury criterion (HIC(d)) while the width is changed by a unit width in a state in which the height is fixed, and then tested again while the height is changed by a unit height and the width is also changed by the unit width, and a height and a width in which a head injury value is 1000 or less are obtained, and the height and the width are the height and width in which the head injury value is 1000 or less.

2. The auxiliary member of claim 1, wherein the injury value is measured while the height is incrementally changed from 0 to 50 mm by a unit height of 5 mm, and the width is incrementally changed from 0 to 100 mm by a unit width of 5 mm.

3. The auxiliary member of claim 1, wherein the roof panel and a distal end of the corrugated portion are formed to be spaced apart from each other by a predetermined gap.

4. The auxiliary member of claim 3, wherein the gap is within approximately 3 to 6 mm.

5. The auxiliary member of claim 1, wherein the HIC(d) follows the protocol of the FMVSS 201U standard of the National Highway Traffic Safety Administration (NHTSA) in the U.S.
